(19) United States
(12) Patent Application Publication
(10) Pub. No.: US 2010/0294967 A1
(43) Pub. Date: Nov. 25, 2010

(54) VALVE ACTUATOR

(75) Inventor: Filippo Dordoni, Cortemaggiore (Piacenza) (IT)

Correspondence Address: YOUNG & THOMPSON, 209 Madison Street, Suite 500, Alexandria, VA, 22314, US

(73) Assignee: DVG AUTOMATION S.P.A., Cortemaggiore (Piacenza) (IT)

(21) Appl. No.: 12/863,803

(22) PCT Filed: Jan. 7, 2009
(86) PCT No.: PCT/IB2009/050030

§ 371 Date: Jul. 21, 2010

(30) Foreign Application Priority Data
Jan. 28, 2008 (IT) PR2008A000007

(51) Int. Cl. F16K 31/44

(52) U.S. Cl. 251/229

(57) ABSTRACT

A valve actuator (1) for converting a reciprocating rectilinear motion into a reciprocating angular rotary motion and/or vice versa, including a pivot (2) for generating an angular rotary motion about its axis (A5), a slider (7) linearly sliding in at least one guide (6) which defines an axis (A1) perpendicular to the axis (A5). The pivot and slider are connected together by elements (11, 12) for rotary-to-rectilinear motion conversion or vice versa, the elements including a pin (12) integral by one end to the pivot (2), whereas the other end slides within a sleeve (11) which freely pivots at (C) on the slider, about an axis (A3) perpendicular to the axis (A3) perpendicular to the axis (A1); any rotation of the pivot (2) about the axis of rotation (A5) parallel to (A3) corresponds to an identical angular rotation of the pin which in turn drives the slider and/or vice versa.

The present invention relates to a valve actuator, having a device for converting a reciprocating rectilinear motion into a reciprocating angular rotary motion and vice versa for use in valve actuators.

Devices are known to be used in the art of valve actuators for converting the rectilinear motion of an actuator into a rotary motion of a valve stem, or vice versa, by a mechanism known as sliding block linkage.

Namely, a sliding block linkage allows conversion of the uniform rotary motion of a flywheel driven by a motor into a reciprocating rectilinear motion.

The object of the present invention is to provide a valve actuator comprising a device that can ensure conversion from reciprocating linear motion to reciprocating rotary motion and vice versa to reduce friction of moving parts and optimize the distribution of sliding components.

These objects and advantages are achieved by a device for converting a reciprocating rectilinear motion into a reciprocating angular motion and vice versa, according to the present invention, which is characterized by the annexed claims.

This and other features will be more apparent from the following description of a few embodiments, which are shown by way of example and without limitation in the accompanying drawings, in which:

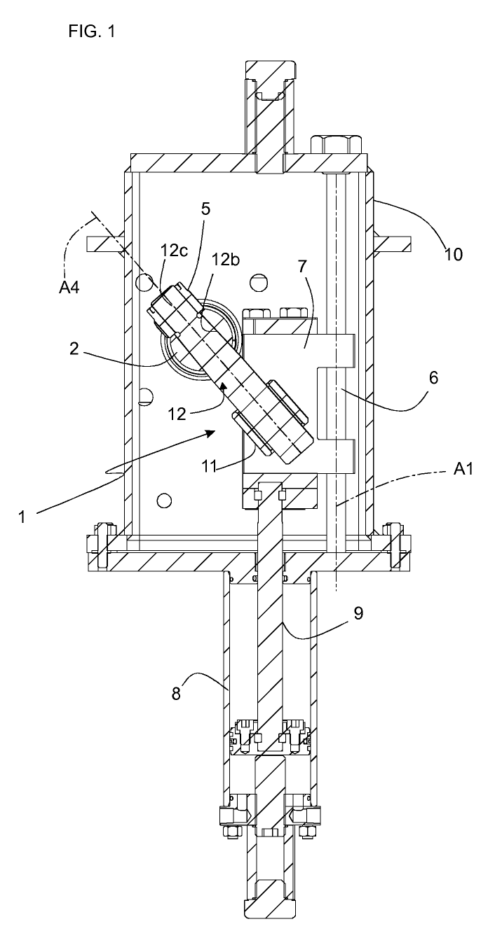

FIG. 1 is a broken-away plan view of a drive device for valve actuators of the present invention,

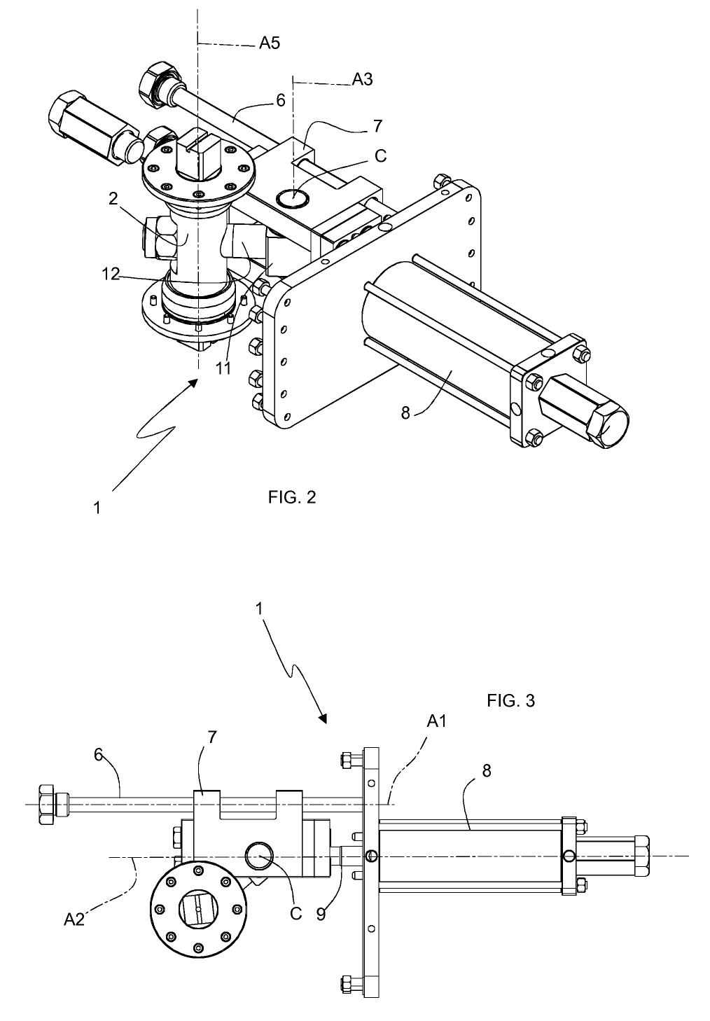

FIG. 2 is a perspective view of the device of FIG. 1,

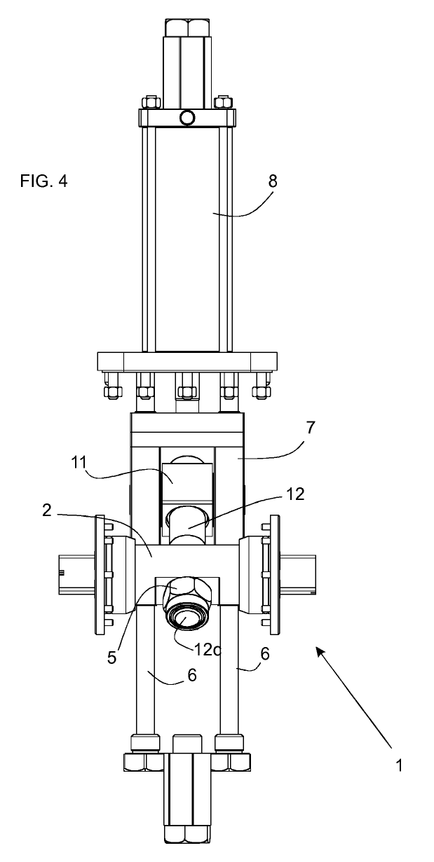

FIG. 3 is a top view of the device of FIG. 2,

FIG. 4 shows a rear view of the device of FIG. 2.

Referring to FIGS. 1, 2, 3 and 4, numeral 1 generally designates an actuator of the type comprising a device for converting a reciprocating rectilinear motion into a reciprocating angular rotary motion in a valve actuator.

Namely, the device 1 comprises a case 10 for housing the required rectilinear/rotary motion converting components.

At least one linear guide 6 is attached to two inner opposite walls of the case 10, with a slider 7 freely sliding therein; said slider 7 being allowed to move by a stem 9 of an actuator cylinder 8, by the kinematic components 11 and 12 as described below, by a pivot 2, depending on the movement to be imparted thereto.

As mentioned above, the slider 7 is acted upon by a stem 9 connected to the slider 7 by mechanical connections of known type, along an axis A2 parallel to the axis A1 of the guide 6; said stem 9 being in turn controlled, for instance by a hydraulic or pneumatic cylinder 8 which is fixed to the case 10 by a flange or equivalent means.

A sleeve 11 is hinged to said slider 7, to freely rotate about an axis A3 that passes through the point C of FIG. 3, i.e. perpendicular to the above axes Al and A2.

In the illustrated embodiment, the sleeve 11 is conveniently located within the slider 7, so that it can be displaced by a substantially barycentric force; nonetheless it might be also located elsewhere, as long as it is connected to the slider 7, without departure from the application scope.

Due to the above described connection between the sleeve 11 and the slider 7, any sliding motion of the slider 7 will cause the sleeve 11 to rotate while maintaining a radial orientation of its axial direction A4, i.e. towards the center of rotation defined by the pivot 2, which will be conveniently fixed to the valve control stem.

The pivot 2 and the sleeve 11 will be connected together with the help of a pin 12, i.e. a mechanical connection member between the two kinematic parts.

One end of this pin 12 is free to slide within the corresponding sleeve 11, whereas the other end has a first conical portion 12b matching the corresponding seat of the pivot 2 and a threaded shank 12c for engagement by a corresponding ring nut 5.

As a result, any rotation of the pivot 2 about the axis of rotation designated by A5 (parallel to A3 and perpendicular to A1, A2, A4) corresponds to an identical angular rotation of the pin 12 which slides relative to the sleeve 11 and drives the slider 7 and the stem 9 and vice versa.

All moving and mutually sliding parts are interfaced by an open bush made of steel+bronze+polytetrafluoroethylene (PFTE) material.

Namely, there are two bushes between the pivot 2 and the flanges, one bush between the pin 12 and the sleeve 11, two bushes between the sleeve 7 and the two guiding bars 6.

1. A valve actuator (1) for converting a reciprocating rectilinear motion into a reciprocating angular rotary motion and/or vice versa, comprising a pivot (2) for generating an angular rotary motion about its axis (A5), a slider (7) linearly sliding in at least one guide (6) which defines an axis (A1) perpendicular to said axis (A5), characterized in that said pivot (2) and slider (7) are connected together by elements (11, 12) for rotary-to-rectilinear motion conversion or vice versa; said elements including a pin (12) integral by one end to said pivot (2), whereas the other end slides within a sleeve (11) which freely pivots at (C) on the slider (7), about an axis (A3) perpendicular to said axis (A3) perpendicular to said axis (A1); any rotation of the pivot (2) about the axis of rotation (A5) parallel to (A3) corresponds to an identical angular rotation of the pin (12) which in turn drives the slider (7) and/or vice versa.

2. A valve actuator (1) as claimed in claim 1, characterized in that the end of the pin that fits into the pivot (2) comprises a first conical section (12b) matching the corresponding seat of the pivot (2) and a threaded shank (12c) for engagement by a corresponding ring nut (5).

3. An actuator (1) as claimed in claim 1, characterized in that said sleeve (11) is located within the slider (7), so that it can be displaced by a substantially barycentric force.
